(19) United States
(12) Patent Application Publication
(10) Pub. No.: US 2026/0268632 A1
(43) Pub. Date: Sep. 10, 2026

(54) SYSTEM AND METHOD FOR NOVELTY DETECTION IN VISUAL DATA

(71) Applicant: National University of Singapore, Singapore (SG)

(72) Inventors: Animesh Gupta, Singapore (SG); Sayan Kumar, Singapore (SG); Viveka Konandur Rajanna, Singapore (SG); Sachin Taneja, Singapore (SG); Massimo Alioto, Singapore (SG)

(21) Appl. No.: 19/491,321

(22) PCT Filed: Jun. 7, 2024
(86) PCT No.: PCT/SG2024/050374

§ 371 Date: Dec. 8, 2025

(30) Foreign Application Priority Data
Jun. 9, 2023 (SG) 10202301635T

(51) Int. Cl. G06V 10/25; G06T 5/30; G06T 7/11; G06T 7/20; G06V 10/46; G06V 10/75; G06V 10/764; G06V 10/82

(52) U.S. Cl. CPC G06V 10/25; G06T 5/30; G06T 7/11; G06T 7/20; G06V 10/462; G06V 10/751; G06V 10/764; G06V 10/82; G06V 2201/07

(57) ABSTRACT

In a described embodiment, a method for detecting novelty in video frames is implemented including acquiring an input frame. The method further includes identifying a preliminary salient region within the input frame and refining the preliminary salient region to generate a refined salient region. A bounding box is computed for the refined salient region. A mean center of the bounding box is calculated and the mean center is tracked across multiple input frames. A distance corresponding to the tracked mean center is calculated. An object corresponding to the bounding box is classified as novel when the distance exceeds a predetermined threshold.

### TECHNICAL FIELD

The present application pertains generally to digital image processing, and in particular systems and methods leveraging novelty detection in visual data within a vision pipeline.

### BACKGROUND

In the field of distributed vision systems, the increased use of self-powered and remotely operated cameras underscores the need for energy-efficient processing solutions. These systems must analyze complex scenes in real-time, typically using on-chip deep neural networks (DNNs). The substantial energy demand of DNNs, combined with the costs associated with wireless data transmission, presents considerable challenges. Traditional methods address these challenges by incorporating low-power motion and saliency detection mechanisms within the vision pipeline, aimed at reducing unnecessary DNN activations. However, these methods often struggle to achieve a balance between low power consumption and the flexibility needed for real-time analysis in varied and changing environments.

Recent advancements have seen the development of hierarchical neural networks tailored for tasks such as object detection and tracking. Although an improvement, the gains in power efficiency are incremental, and the scope of these systems is usually confined to specific tasks like face or person detection. This limitation often stems from the specialization of the front-end processing or a significant reduction in the size of the neural network front-end, constraining their versatility and effectiveness in diverse settings.

Furthermore, the process of detecting new content in videos often involves computational complexity that is quadratic. This characteristic can result in scalability issues as video resolution increases, subsequently elevating power and computational demands.

Therefore, it is desirable to provide a method and system that leverages novelty detection for video analysis to address the disadvantages or limitations of the existing technologies or, at the very least, provide the public with a useful alternative.

### SUMMARY

The present disclosure aims to provide new and useful systems and methods for digital image processing, and in particular leveraging novelty detection in visual data within a vision pipeline.

In broad terms, the present disclosure proposes a method for processing video frame pixels including: receiving video frame pixels of a video frame and dividing the video frame into tiles; processing each tile to identify a salient region; applying a structured pattern to evaluate differences between a pair of pixels within each tile to evaluate the salient region; processing the evaluated salient region to detect a novel object corresponding to the video frame; and storing the novel object for further processing by a neural network.

In particular embodiments, the method may include forming a bounding box around the salient region; tracking the movement of the bounding box across multiple video frames; and comparing positions of the bounding box between the multiple video frames.

In implementations, the comparing of positions of the bounding box includes calculating a Manhattan distance between a centre of the bounding box in a first and a centre of the bounding box in a subsequent frame, to assess a movement of an object within the multiple frames.

In particular embodiments, the forming of the bounding box includes implementing a connected component analysis to identify a salient region associated with non-overlapping objects within the multiple frames.

In implementations, the connected component analysis computes a proximity or similarity in pixel values to identify a connected pixel group.

In some embodiments, the tracking of the movement of the bounding box across multiple video frames includes calculating a mean center of the bounding box for a first frame and a mean center of the bounding box for a second frame.

In implementations, the mean center corresponding to the first frame and the mean center corresponding to the second frame are compared to determine object novelty.

In particular embodiments, the method may include determining whether the movement of the bounding box exceeds a predetermined threshold, wherein the movement exceeding the threshold indicates an object corresponding to the bounding box is novel.

In particular embodiments, the method may include pre-processing the stored novel objects for compatibility with one or more specific neural network applications.

In some embodiments, the method may include refining the salient regions by applying an erosion process followed by a dilation process to the salient regions.

In particular embodiments, the density or distribution of the structured pattern is reconfigurable according a complexity of the received video frame pixels of the video frame.

In some embodiments, the method may include using a Finite State Machine to control sequential operations corresponding to the processing of the salient region and the detection of the novel object.

In implementations, the processing of the salient region includes ceasing further processing of the video frame if no salient pixels are found.

The present disclosure further proposes a method for detecting novelty in video frames including acquiring an input frame; identifying a preliminary salient region within the input frame; refining the preliminary salient region to generate a refined salient region; computing a bounding box for the refined salient region; calculating a mean center of the bounding box and tracking the mean center across multiple input frames; calculating a distance corresponding to the tracked mean center; and classifying an object corresponding to the bounding box as novel when the distance exceeds a predetermined threshold.

The present disclosure further proposes a system for identifying novel objects in a video sequence including a data processing module configured to receive and process image frames from a video sequence, divide each frame into tiles to assess salient regions and segment the salient regions column by column into distinct clusters and assign labels to each cluster; a label management module configured to merge labels in neighbouring clusters, thereby forming an expanded group of clusters, wherein the expanded group of clusters are stored and objects within the expanded group of clusters are assessed for novelty based on positions within adjacent frames; and a thresholding module configured to apply a thresholding mechanism to the expanded group of clusters based on a size or position of the expanded group of clusters.

In some embodiments, the thresholding module is configured to discard objects that are either minuscule or outside pre-defined regions of interest based on a size of a bounding box.

In implementations, the expanded group of clusters correspond to bounding boxes that are stored in a table, wherein the bounding boxes are defined by a plurality of attributes.

In particular embodiments, label management module includes a label buffer that stores label and position information corresponding to the neighbouring clusters.

In some embodiments, the thresholding module is further configured to execute a comparison algorithm to determine if the size of a bounding box falls within a range indicative of salient objects, wherein objects falling outside this range are discarded.

In implementations, the data processing module may include an encoder module configured to encode contiguous pixel sequences within the image frames of the video sequence.

In particular embodiments, the thresholding module includes a feature extraction module configured to compute bounding boxes and assess novelty of an object within the bounding boxes.

In some embodiments, the feature extraction module is further configured to calculate the mean center of the bounding boxes and to evaluate the movement of objects based on the location of the mean center over time.

In particular embodiments, the label management module is configured to merge the labels of the neighbouring clusters based on comparing the labels to determine a connectivity among the labels.

In implementations, the system may include a feature table for recording dimensions and positions of bounding boxes associated with objects identified as novel by the threshold module.

In embodiments, the thresholding module may be configured to utilize a Manhattan distance calculation to quantify a movement of a mean center of a bounding box between the adjacent frames.

The above description is provided as an overview of some implementations of the present disclosure. Further description of those implementations, and other implementations, are described in more detail below.

### BRIEF DESCRIPTION OF THE DRAWINGS

Embodiments of the invention will now be explained for the sake of example only, with reference to the following figures in which:

FIG. 1A is a schematic representation of a video processing pipeline for a distributed computing system, according to an embodiment of the present disclosure.

FIG. 1B is a schematic representation of a saliency detection and refinement process within the video processing pipeline, according to an embodiment of the present disclosure.

FIG. 2 is a flowchart illustrating steps of the video processing pipeline for input into a neural network, according to an embodiment of the present disclosure.

FIG. 3A is a schematic representation of a novelty detection process within the video processing pipeline, according to an embodiment of the present disclosure.

FIG. 3B is a flowchart illustrating steps of the novelty detection process, according to an embodiment of the present disclosure.

FIG. 4 is a block diagram showing pipelined stages of the novelty detection process, according to an embodiment of the present disclosure.

FIG. 5 is a set of histograms showing distributions of the number of run lengths per column across salient frames processed by the novelty detection engine within the video processing pipeline, according to an embodiment of the present disclosure.

FIG. 6 is a schematic showing a chip layout and related timing diagram for a video pipeline, according to an embodiment of the present disclosure.

FIG. 7 is a set of matrices and histograms showing performance outcomes of the novelty detection process in various environmental scenarios, according to an embodiment of the present disclosure.

FIG. 8 is a graph showing the power consumption distribution of various components within the video processing pipeline, according to an embodiment of the present disclosure.

FIGS. 9A and 9B show the performance of the novelty detection engine in identifying novel content within video frames in conjunction with handling potential false positives due to occlusion, according to an embodiment of the present disclosure.

FIG. 10 is a block diagram showing a technical architecture of a novelty detection engine, according to an embodiment of the present disclosure.

### DETAILED DESCRIPTION

Embodiments will now be discussed with reference to the accompanying FIGs, which depict one or more exemplary embodiments. These embodiments are described in sufficient detail to enable those skilled in the art to practice the embodiments and it is to be understood that mechanical, logical, and other changes may be made without departing from the scope of the embodiments. Therefore, embodiments may be implemented in many different forms and should not be construed as limited to the embodiments set forth herein, shown in the FIGs, and/or described below.

As used in this disclosure, the terms “component,” “module,” “system,” “apparatus,” “interface,” or the like are generally intended to refer to a computer-related entity, either hardware, a combination of hardware and software, software, or software in execution. For example, a component or a module may be, but is not limited to being, a process running on a processor, a processor, an object, an executable, a thread of execution, a program, and/or a computer. By way of illustration, both an application running on a controller and the controller can be a component or a module. One or more components/modules may reside within a process and/or thread of execution and a component may be localized on one computer and/or distributed between two or more computers.

Herein, the term “saliency detection” refers to the computational identification and analysis of elements within visual data that are likely to draw the observer's focus, differentiated from their surroundings by distinct features such as contrast, color, edges, or motion. For example, this detection process may prioritize areas within an image or video that stand out to an observer's vision, often for the purpose of reducing the volume of data to be processed or to enhance the effectiveness of further image processing tasks.

Herein, the term “Connected Component Analysis (CCA)” refers to the computational procedure within digital image processing for identifying and grouping adjacent pixels that exhibit similar visual characteristics, thereby isolating connected regions which can be associated with distinct entities or features within the image.

Herein, the term “Bounding Box Estimation” refers to the method by which a rectangular frame is calculated to encompass a region of interest within a visual dataset. This frame may define the periphery of salient features or objects detected in an image, creating a reference for their location and spatial dimensions in a given plane. The estimation may be informed by or follows the pixel groupings identified through CCA.

Herein, the term “Feature Table” refers to an organized data structure utilized to catalog and/or access attributes and descriptors of detected objects or phenomena in a dataset. For example, it may serve as a systematic repository for storing such attributes as location, size, and temporal information for use in further processing stages.

Herein, the term “Deep Neural Network (DNN)” refers to a sophisticated, multi-layered computational model designed to process input data through a series of algorithmic stages, each contributing to the model's ability to perform complex tasks such as classification, pattern recognition, or predictive analysis in a manner akin to human cognitive processes.

Herein, the term “Activity Reduction” refers to methods and techniques aimed at minimizing the computational and power resources expended during the processing of visual data. This may be achieved by selectively engaging the system's processing capabilities only for those data segments that have been deemed essential or novel, as determined through saliency detection and novelty assessment procedures.

Herein, the term “Manhattan distance” refers to a metric used to calculate the total sum of the absolute differences between the Cartesian coordinates of points in a grid-like path. Within the context of this disclosure, this distance measure may be utilized to quantify the movement or change in position between objects across frames in image processing, particularly when assessing whether the movement of objects within bounding boxes exceeds a certain threshold, thereby indicating novelty or significant change.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ) , optical disks (e.g., compact disk (CD), digital versatile disk (DVD) . . . ), smart cards, and flash memory devices (e.g., card, stick, key drive . . . ).

Unless otherwise defined, all terms (including technical and scientific terms) used herein are to be interpreted as is customary in the art. It will be further understood that terms in common usage should also be interpreted as is customary in the relevant art.

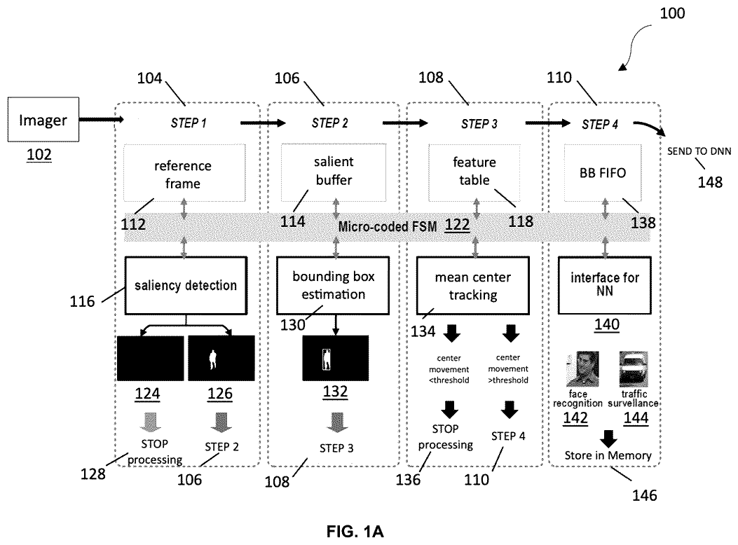

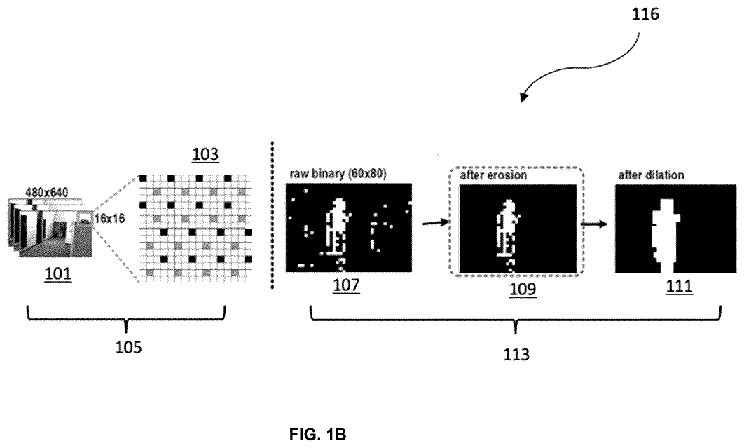

FIG. 1A is a schematic representation of a video processing pipeline 100 for a distributed computing system, according to an embodiment of the present disclosure.

As shown in FIG. 1A, an imager 102 captures video frames passed through a lens. The lens represents an optical component that focuses an incoming light onto the imager. In an embodiment, the imager 102 may capture video in VGA resolution and grayscale format, simplifying the amount of image data for processing by reducing colour data.

In the initial stage 104 of the video processing pipeline, the captured video data is inputted into the system 100 for saliency detection and related refinements (erosion and dilation) 116. Reference frame parameters 112, which may be implemented using SRAM, stores reference data (such as baseline image data or detection parameters) that facilitate analysis of inputted video data for detecting salient features.

During Saliency Detection 116, the raw video data of each captured frame is analyzed to determine the presence of salient pixels—those that stand out due to characteristics like motion, contrast, or other predefined features that indicate potential importance. The outcome of saliency detection 116 leads to one of two actions: If No Salient Pixels 124 are detected, meaning the frame lacks regions of interest, the system 100 decides to STOP processing for the current frame 128. This conserves computational resources, as frames without salient features do not require further analysis. If a Salient Object is Found 126, the system 100 acknowledges that there are regions within the frame that require additional image processing and proceeds to Step 2 106. In this case, the frame, or at least the relevant salient information, is stored in the Salient Buffer 114 which may have a 4.68 Kb Latch Memory. This buffer 114 acts as a holding area for the salient data before it's passed on to the next steps for bounding box estimation 130 and additional processing.

The methodology of step 1 104 ensures computational resources are allocated selectively, prioritizing frames that exhibit a potentially significant object or features of interest, as determined by the saliency detection module 116 using the reference frame parameters 112.

A micro-coded Finite State Machine 122 is tasked with controlling the sequential operations of the system. It may use microcode to manage the complex decision-making processes that occur at each step of the vision pipeline 100, ensuring the correct workflow between saliency detection 116, bounding box estimation 130, and other subsequent stages.

Step 2 106 involves a bounding box estimation 130 which processes the identified salient regions. After the saliency detection step, the video frames that contain salient objects or regions are stored in salient buffer 114. The salient buffer 114, with its designated latch memory, stores the relevant image data and identified salient regions of interest for further processing.

A bounding box estimation 130 draws bounding boxes around the identified salient regions that is stored in the salient buffer 114. The bounding box estimation 130 may use Connected Component Analysis (CCA) which identifies groups of pixels within an image that are connected based on their saliency, which can be defined by similar pixel values and proximity. For each group of connected pixels (each representing a salient region), CCA calculates the smallest rectangular bounding box 132 that can enclose the group. These bounding boxes 132 are designed to encapsulate discrete, non-overlapping objects in the image. The bounding box 132 may include data such as the coordinates (e.g., top-left and bottom-right corners), dimensions (width and height), and temporal identifiers of each bounding box that define the spatial boundaries of objects detected as salient in the video frame. The coordinates, dimensions, and/or temporal identifiers of each bounding box 132 are stored in a feature table 118. This table 118 organizes the data efficiently, facilitating easy access for further analysis by the pipeline 100 such as object tracking or monitoring changes in the objects over time.

After bounding boxes have been established around salient objects (previous steps), the pipeline 100 proceeds to Step 3 108 involves tracking these objects over time. The primary task of Step 3 108 is to monitor the movement and changes of the objects identified by their bounding boxes across multiple video frames.

A mean center tracking module 134 is used to calculate a geometric center of each bounding box (the mean center) across multiple frames to determine the movement of objects. Tracking the mean center allows the system to understand how objects are behaving over time—whether they're stationary, moving within the frame, or changing in size. An output from mean center tracking 134 may indicate whether the movement of the center of a bounding box across frames exceeds a certain threshold, suggesting significant movement or change. This is an important piece of data for determining novelty, as it signals that something new or previously unobserved is occurring with the object.

If an object's center movement is greater than the threshold, it is considered novel, and the bounding box (BB) for this object is stored in BB FIFO 138 and the pipeline 100 proceeds to Step 4 110 for further processing. This FIFO (First-In, First-Out) buffer 138 is designated for objects that have met the criteria for novelty and are queued up for further analysis in Step 4 110.

Conversely, the system may evaluate the output from the mean center tracking and determine the movement is not substantial—specifically, the movement is less than the threshold. If the movement does not meet the threshold for novelty, the system will STOP processing 136 for the current frame with respect to that object. This means the object is not queued in the BB FIFO 138, thereby saving computational resources and focusing attention only on those objects with significant changes. The novelty detection processing of Step 3 108 serves as an important decision-making juncture for processing the flow of the pipeline 100 based on the determined movement of the object.

At step 4 110, objects that have shown significant movement (as identified by mean center tracking 134) are stored in BB FIFO 138. At this stage, the stored novel objects will be prepared for processing by a Deep Neural Network (DNN). Interface 140 takes the information from the novel objects queued in FIFO 138 and prepares it for further analysis by a neural network. For example, the interface 140 may format the data appropriately and may involve additional pre-processing steps like normalization or scaling.

Before sending data to the neural network, the interface 140 may crop and/or store only relevant regions of the novel object and/or the frame for compatibility with or optimization for specific DNN applications. These specific DNN applications may include face recognition 142 or traffic surveillance 144. Once the relevant data has been cropped or pre-processed for the specific application, it's stored in memory 146 such as Static Random-Access Memory (SRAM). SRAM may act as a fast-access memory cache that holds the relevant data before it's sent to the DNN 148. The application-specific pre-processed data that is stored in the memory 146 is sent to the DNN 148 for additional processing by the neural network.

The DNN will subsequently perform the specific tasks it has been designed to perform such as identifying individuals in face recognition to classifying vehicles in traffic surveillance. The analysis conducted by the DNN may be based on the neural network's training and can vary widely depending on the specific tasks. The outcome of the DNN could include classification results, identification confirmations, or alerts for human operators.

FIG. 1B is a schematic representation of a saliency detection and refinement process 116 within the video processing pipeline, according to an embodiment of the present disclosure.

As an initial step, an image frame 101 may be sectioned into 60×80 tiles. Each title of the image frame 101 may be analysed individually to detect salient features within the frame. The saliency detection and refinement process 116 then applies a structural pattern 103 over each tile to evaluate pixel pairs for saliency. This pattern's 103 density is adjustable, allowing a trade-off between energy consumption and the quality of saliency detection. Unlike fixed or random patterns, this pattern 103 density or distribution of its pixel elements can be reconfigured to adapt to different scene complexities. In the saliency detection and refinement process 116, the saliency detection process 105 may be determined by evaluating differences in pixel pair values across the structural pattern 103.

Following the initial saliency detection 105, a raw binary image or map 107 is output. This binary map 107 represents the initial detection of salient pixels within the frame. The white pixels indicate areas that have been identified as salient based on the pixel pair value differences.

To improve the quality of the saliency map 107, a refinement process 113 is implemented by system 116 which provides a more precise representation of truly salient features in the image. In the first step of the refinement process 113, an erosion step is applied, which removes noise by suppressing isolated salient pixels. This step helps in reducing false positives in the saliency detection. A post-erosion saliency map 109 is generated, which is the saliency map after the erosion is applied. The map 109 shows a more refined set of salient features, with spurious noise elements removed. Following erosion, a second step of the refinement process is applying dilation, which helps in restoring the size and shape of salient objects that may have been eroded too much. This dilation results in the final saliency map 111, where true salient features are highlighted, and the objects are more defined and distinct.

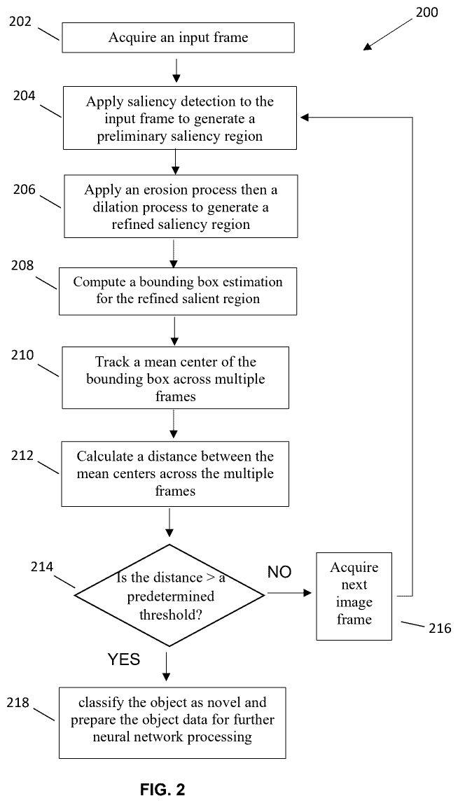

FIG. 2 is a flowchart 200 illustrating steps of the video processing pipeline 100 for input into a neural network, according to an embodiment of the present disclosure.

As an initial step 202, the pipeline 100 acquires a video frame through an imager 102. The video frame may have passed through a lens to focus a light onto the imager 102.

In step 204, the pipeline 100 applies an initial saliency detection process 105 to the input frame to generate a preliminary saliency region or raw binary map 107. The preliminary saliency region 107 corresponds to one or more identified regions of a frame with distinctive visual features. This salient region is determined by comparing pixel values against stored reference data, isolating areas that exhibit characteristics such as unusual motion or contrast, indicative of potential significance.

In step 206, an erosion process is applied to the preliminary saliency region 107 followed by a dilation process to generate a refined saliency region 111. This refinement process 113 is important for improving the fidelity of the saliency map, preparing it for more reliable novelty detection.

In step 208, the process 200 computes bounding boxes for the refined salient regions using an estimation based on Connected Component Analysis (CCA). CCA may form bounding boxes around connected salient regions that are associated with non-overlapping objects within the frame, therefore isolating distinct regions of interest and ensuring that their corresponding bounding boxes remain separate. The characteristics of each box, representing unique objects, are stored in a feature table 118 for further object tracking and analysis.

In step 210, the process 200 tracks the geometric center, or mean center, of each bounding box stored in feature table 118 across multiple frames. The mean center tracking module 134 determines the behavior of one or more objects over time, monitoring whether they remain stationary, move, or change in size.

In step 212 and following the mean center tracking, a distance between the mean centers across the multiple frames is calculated. This calculation measures the extent of movement for each object over a period of time. In an embodiment, the calculated distance may correspond to a Manhattan distance between the mean centers of bounding boxes tracked over successive frames. The Manhattan distance may quantify how much an object within a bounding box has moved from one frame to the next by summing the absolute differences in their coordinates.

In step 214, the computed distance of step 212 is compared to a predetermined threshold to determine the novelty of the object. If the distance is less than the threshold, the object is considered non-novel, meaning the object was likely present in previous frames and has not moved beyond the pipeline's threshold for significant movement. In such cases, the process 200 moves on to acquire the next frame 216 and apply saliency detection 204 without further analyzing the object, ensuring efficient use of computational resources.

If in step 214, the computed distance is greater than the predetermined threshold, it suggests the object's motion is significant enough for the object to be considered novel. In such a case, the process 200 moves to step 218 and classifies the object as novel and prepares the object data for further neural network processing. Here, the data pertaining to the object, which may include its bounding box coordinates and the frame in which it was detected, is further formatted or processed to be inputted into a neural network for tasks such as object recognition or behavior analysis.

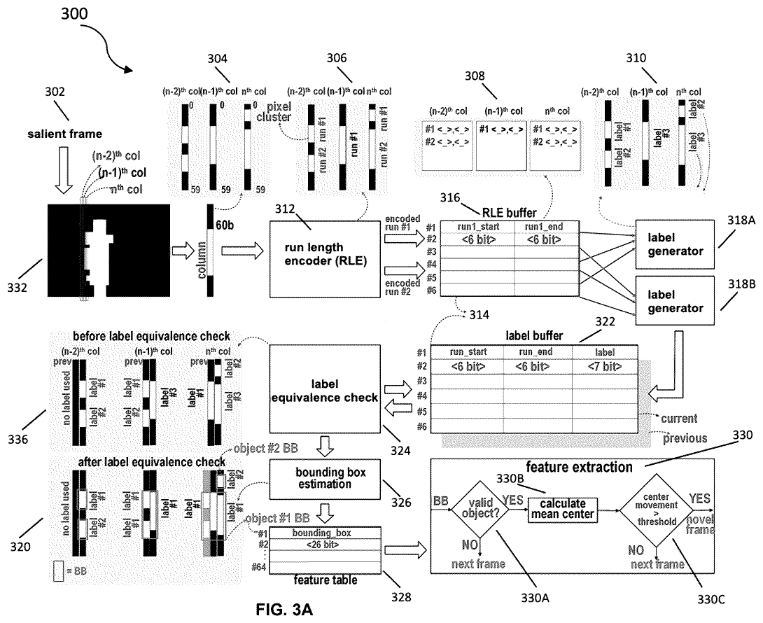

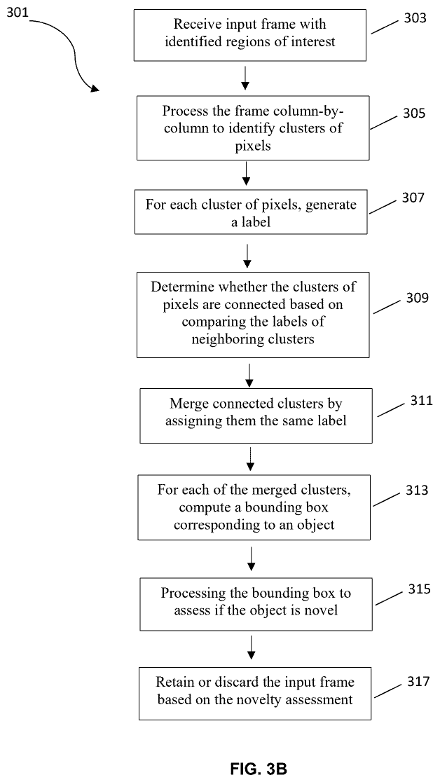

FIG. 3A is a schematic representation 300 of a novelty detection process within the video processing pipeline, according to an embodiment of the present disclosure. This system 300 is designed based on geometrical analysis principles, enabling it to function independently of object-specific or task-specific parameters and thus offering wide-ranging applicability across diverse domains. FIG. 3B is a flowchart 301 illustrating steps of the novelty detection process, according to an embodiment of the present disclosure. In the description that follows, the architectural components and processing sequence depicted in FIG. 3A will be referenced alongside the procedural steps presented in FIG. 3B to detail the workflow of the novelty detection system 300.

In step 303, the novelty detection system 300 receives a salient frame 302 that has undergone saliency detection to identify regions of interest. The salient frame 302, presented as a binary image 332, highlights relevant salient regions.

In step 305, the process 301 takes the binary image 332 (the salient frame) and begins to analyze the frame one column at a time, employing a run length encoder (RLE) 312 that feeds on a single column sequentially. This approach breaks down the complex image into more manageable parts, allowing the system to focus on individual columns sequentially, which is an initial step for encoding the runs of pixels.

During the salient frame processing stage, represented by 304, salient pixels within each column are identified. Subsequently, the clustering stage, represented by 306, groups these identified salient pixels into contiguous clusters. As the system 300 progresses through the columns, these clusters undergo a progressive expansion, merging with adjacent clusters when continuity is detected. This aggregation forms increasingly larger 2D clusters, which ultimately lead to the creation of bounding boxes around detected objects.

The RLE 312, in step 305, operates by scanning each column of pixel clusters (grouped in module 306) and encoding sequences of contiguous pixels, or “runs.” The RLE 312 notes the start and end points of each contiguous sequence of salient pixels within a column 308 and stores this information in an RLE buffer 316. In example embodiments, the RLE 312 may evaluate two runs per cycle, a maximum of six runs per column, and takes three cycles per column. The RLE buffer 316 captures run length data, specifically recording the start and end coordinates of each pixel run within the individual columns.

Step 307 involves the generation of labels for each pixel cluster. Label generators 318A and 318B assign labels to the runs recorded in the RLE buffer 316. These label generators enhance throughput by efficiently reusing currently unused labels and manage labeling across different parts of the image concurrently. The labels assist in tracking the movement and evolution of objects over time and are represented in module 310.

Before-Label Equivalence Check 336 depicts the system 300 at a stage where clusters in adjacent columns are labeled but not yet analyzed for connectivity. Step 309 determines whether the clusters of pixels are connected by comparing the labels of neighboring clusters. This comparison of labels may be performed using 8-connectivity, which considers diagonal adjacency.

Step 311 involves merging connected clusters by assigning a common label, effectively recognizing them as contiguous parts of the same object. The label equivalence check module 324 performs this comparison and merging, updating labels across columns to reflect cluster connectivity. The label buffer 322 stores run positions along with their corresponding labels, aiding subsequent processes like the label equivalence check 324, which compares and updates labels based on the connectivity of neighbouring clusters. In example embodiments, the label buffer 322 and the RLE buffer 316 may be configured separately 314 to support a pipelined architecture.

Once the label equivalence check, performed by module 324, confirms the connectivity of clusters across columns, the system computes bounding boxes to encapsulate these expanded clusters. After-Label Equivalence Check module 320 then merges connected clusters into single objects, while disconnected clusters retain their original labels.

In step 313, the bounding box estimation module 326 processes the output from module 324 to create bounding boxes around these connected salient regions. The dimensions of each bounding box are precisely defined by four key components: height, width, and the x-y coordinates of the origin, which pinpoint the bounding box's position within the frame. These bounding boxes, specified by their size parameters, are then recorded in the feature table 328. To maintain focus on objects of significant salience, the system may implement a thresholding step that filters out objects that are either too small—i.e. representing noise—or those outside predefined regions of interest. Objects that meet this relevance criteria are retained for further novelty analysis.

In step 315, the feature extraction module 330 analyzes bounding boxes to determine object novelty. The analyzed features may include dimensions, positions, and other attributes critical for identifying novelty. Initially, the feature extraction module 330 may assess whether the detected object meets certain criteria 330A to be considered valid. This includes size thresholds or relevance to pre-defined regions of interest. Next, the module determines whether the object within the bounding box represents novel content. This is assessed by calculating a mean center 330B, involving computing the geometric center of the bounding box by averaging the coordinates of its corners. The mean center provides a single point representing the object's position within the bounding box. Once this mean center is computed, the location of the mean center over time can be further tracked to evaluate the object's movement. This tracking involves computing Manhattan distances to quantify object movement. Additional computations may include velocity calculation (i.e., changes in the position of the mean center across frames to calculate the movement speed and direction of the object) and occlusion estimation (considering the position and trajectory of the mean center to determine if an object is being occluded or is occluding another object when moving). If it is determined that the center movement exceeds a certain threshold 330C, the object and the associated frame are deemed novel.

In the final step of process 301, the system 300 determines whether to keep or discard the frame based on the novelty assessment of step 315. Frames determined to contain significant changes are retained for further processing, potentially involving DNN analysis, while those without such determined changes are discarded to reduce computing power and storage. This functionality underscores the system's capacity for real-time processing, facilitating the efficient management of pertinent data.

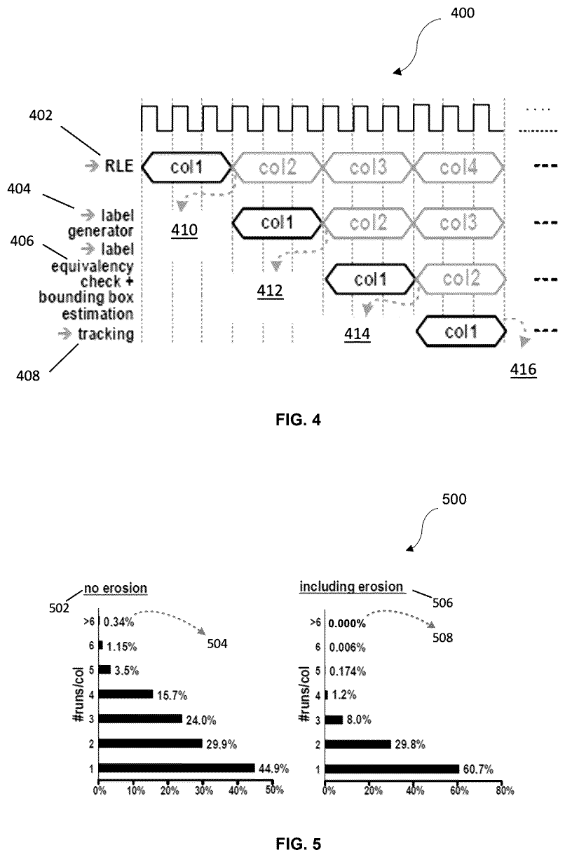

FIG. 4 is a block diagram 400 showing pipelined stages of the novelty detection process, according to an embodiment of the present disclosure.

As shown in FIG. 4, a Run Length Encoder (RLE) 402 starts by estimating bounding boxes for salient objects using Connected Component Analysis (CCA). A saliency map, which highlights areas of interest, is processed one column at a time using the RLE 402. The RLE 402 calculates the start and end points of pixel clusters indicating saliency within each column and records these ‘runs’ in the RLE buffer, as indicated by numeral 410. A label generator 404 then assigns labels to each pixel cluster, reusing labels when possible to enhance efficiency. The labels are further stored in a current label buffer, as indicated by numeral 412. A label equivalence check and boxing box estimation process 406 then checks for equivalence of labels in adjacent columns to identify if they belong to the same object and merges runs if they are part of the same object, creating a bounding box around the object. The resulting bounding boxes for objects are then stored in a feature table and corresponding processed label data are stored to a previous buffer as indicated by numeral 414. Once the bounding boxes are established, a tracking process 408 begins. The tracking process 408 may involve monitoring a mean center of bounding boxes across frames to track movement and assess novelty. During the tracking process, novel bounding boxes (BBs) are stored in a First In First Out (FIFO) queue, labeled as 416, indicating a detection of novel objects for further processing.

In traditional image processing systems, a computational complexity that scales quadratically with the number of processed pixels or, more specifically, with the product of the width and height of the image (denoted as O(W×H), where W is the width and H is the height) is achieved. In contrast, the computational complexity of the system of FIG. 4 is linear, as denoted as O(#columns+3), which means the amount of computation needed increases linearly with the number of columns in the image. By reducing the complexity from quadratic to linear, the system can handle larger frames or higher resolutions without a proportional increase in computation time or power consumption, which is crucial for power-sensitive applications like distributed vision systems.

### Experimental Results

The following section describes various experiments conducted to evaluate embodiments of the disclosure. Some of these experiments illustrate embodiments of the disclosure other than those discussed above. The datasets used for the following testing and experiments come from publicly available datasets provided by changedetection.net (CDNet datasets).

FIG. 5 is a set of histograms 500 showing distributions of the number of run lengths per column across salient frames processed by the novelty detection engine within the video processing pipeline, according to an embodiment of the present disclosure. This analysis shows a variance in distribution resulting from the implementation of an erosion step within the saliency detection phase.

### Left Histogram 502 (No Erosion Step in Saliency Detection)

The left histogram 502 shows the percentage of columns with a given number of runs when no erosion step is included in the saliency detection process. There is a small percentage of cases 504 where the number of runs per column exceeds six, which is only 0.34%. This suggests that even without the erosion step, the occurrence of more than six runs per column is infrequent. Most columns have one run, as shown by the largest bar at 44.9%, suggesting a significant continuity in pixel values. However, there is a spread across up to six runs, with each subsequent number of runs having a progressively smaller percentage of columns.

### Right Histogram 506 (Including Erosion Step in Saliency Detection)

The right histogram 506 illustrates the percentage of columns with a certain number of runs when an erosion step is included in saliency detection. Here, the percentage of columns with more than six runs 508 drops to 0.000%, which effectively eliminates cases that would exceed the run length encoder's (RLE) set capacity. The inclusion of the erosion step significantly increases the percentage of columns with a single run to 60.7%, further demonstrating the effectiveness of the erosion step in streamlining the saliency detection process. This simplification results in fewer, more extended runs, reducing the computational workload for the NDE.

As shown in FIG. 5, by incorporating the erosion step, the system more effectively identifies salient regions, as evidenced by the increase in single-run columns and the elimination of instances with more than six runs. This confirms the design choice of capping the number of runs at six per column for the proposed system's RLE process. The removal of isolated pixels through erosion contributes to reducing spurious runs, allowing for a more streamlined and energy-efficient novelty detection process, crucial for power-sensitive applications like distributed vision systems.

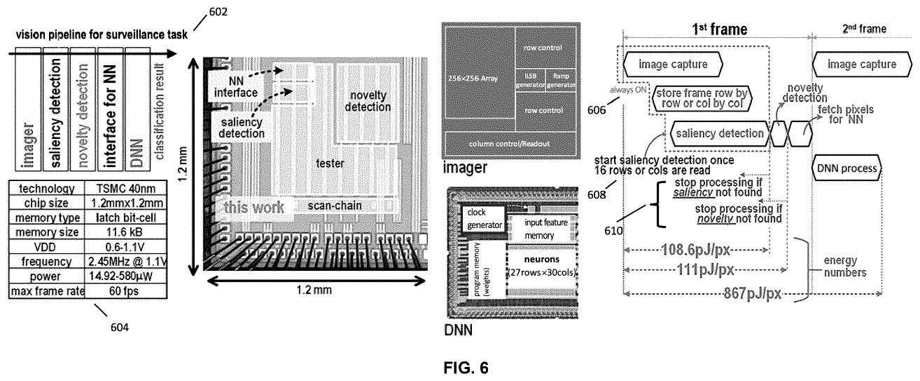

FIG. 6 is a schematic showing a chip layout and related timing diagram for a video pipeline, according to an embodiment of the present disclosure.

The vision pipeline 602 includes an imager, saliency detection, novelty detection, interface for a neural network (NN), and DNN processing. The technical specifications 604 provide details about the physical and operational characteristics of a chip designed for a vision pipeline. As shown in FIG. 6, the technical specifications 604 may include technology, chip size, memory type and size, Voltage (VDD), Frequency, Power, Max Frame Rate.

In an embodiment, the image capture, storage (row-by-row or column-by-column), and saliency detection of the first frame is in “always ON” status 606 for frame capture. The timing diagram provides a saliency detection phase 608 of the first frame where the system starts analysing the captured frame for salient features as soon as enough data is available. Subsequent steps 610 in the timing diagram that follow the saliency detection 608 are evaluated. In these subsequent steps 610, if no saliency is detected, the processing stops. If saliency is detected but if no novelty is found, the processing also stops. If novel content be found, then the information is passed on for NN processing. This “conditional if” mechanism helps to enhance efficiency and reduce unnecessary computational load. By leveraging this sequence of operations, components of the vision pipeline operate with minimal delay, contributing to the pipeline's ability to process surveillance data at high processing speeds, such as a frame rate of 60 fps.

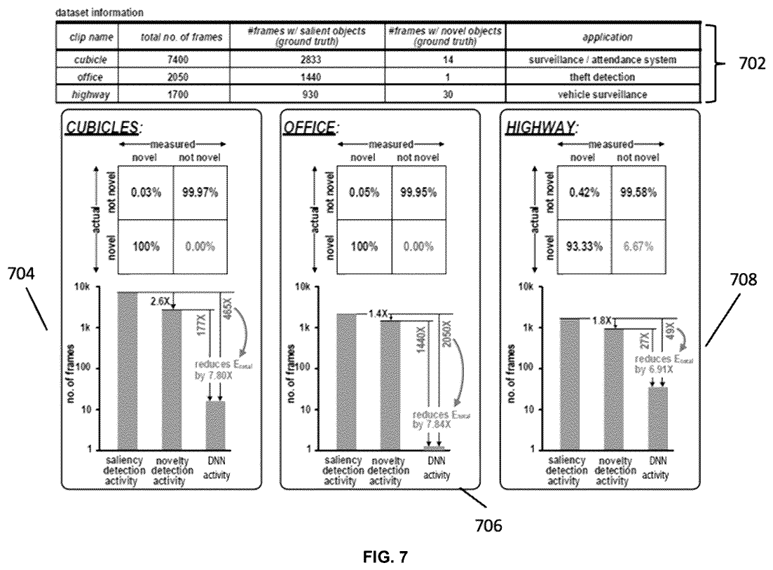

FIG. 7 is a set of matrices and histograms showing performance outcomes of the novelty detection process in various environmental scenarios, according to an embodiment of the present disclosure.

Dataset details 702 are provided for each setting (cubicle, office, and highway). The dataset details 702 include number of frames in the dataset, the count of frames with salient and novel objects (as per ground truth), and the intended use cases like surveillance, theft detection, and vehicle surveillance.

In the experiments, the NDE manages to maintain a low rate of false negatives across different environments, ranging from 0% to 6.67%. This indicates that the NDE is effective at correctly identifying novel objects in a scene without missing many that should have been detected. Lower false negative rates are crucial for applications where missing an object can lead to significant consequences, such as security or surveillance systems.

The system achieved substantial reductions in DNN activity, which also vary based on the scene's complexity and activity level. For example, a highway environment 708 with multiple objects moving or appearing/disappearing achieved a 26.5 reduction in activity. An office setting environment 706 achieved more than a 1000× reduction in activity, suggesting that in quiet simple environments with less frequent changes, the system can drastically reduce unnecessary analyses, thus saving significant energy. For a cubicle environment 704, the NDE system had similar high performance as the office environment 706 in detecting novelty with a 100% accuracy rate for identifying novel content (no false negatives).

The experiments show that novelty detection is much more effective in reducing activity compared to saliency detection (only 1.42-2.6×), regardless of the nature of the scene. This comparison shows the enhanced efficiency of incorporating novelty detection into the vision pipeline, as it significantly reduces the computational load by not re-processing non-novel parts of the scene. Coupled with data on DNN and imager energy consumption, the reductions in computational activity translate into overall energy savings of between 6.91× and 7.84×.

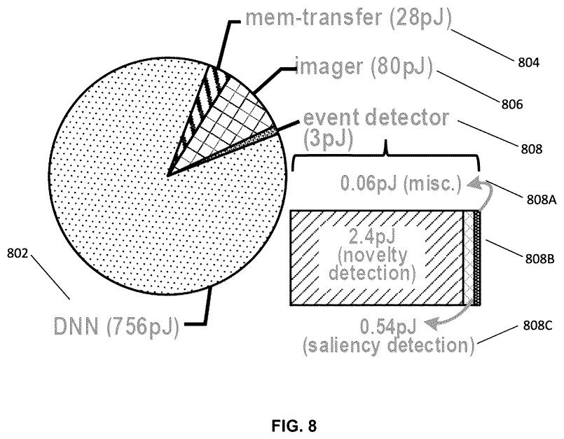

The chart of FIG. 7 outlines various detection activities within a video processing system. Saliency detection activity measures the total number of frames processed, assuming the saliency detection is always active. Novelty detection activity counts the frames with detected salient objects, while DNN (Deep Neural Network) activity focuses on frames with novel objects. The different detection activities are specified as FD (Face Detection), FR (Face Recognition), and VS (Vehicle Recognition), providing an overview of the system's capability to detect and recognize salient and novel objects in various scenarios. FIG. 8 is a graph showing the power consumption distribution of various components within the video processing pipeline, according to an embodiment of the present disclosure. FIG. 8 shows a breakdown of energy computation per pixel per frame for various components of vision pipeline measuring during processing of the vision pipeline.

As shown in FIG. 8, DNN (Deep Neural Network) 802 consumed the most energy per pixel per frame in the system at 756 picojoules (pJ). The memory transfer component 804, corresponding to memory transfers, consumed 28 pJ. The imager 806 had an energy consumption of 80 pJ. The event detector 808 had a total energy consumption of 3 pJ, in which the saliency detection 808C consumed 0.57 pJ, the novelty detection 808B consumed 2.4 pJ, and other miscellaneous energy costs 808A within the event detector consumed 0.06 pJ. The novelty detection 808B is the primary consumer of energy within the event detector 808, with the transition from quadratic to linear complexity in CCA helping to mitigate some of its energy demands.

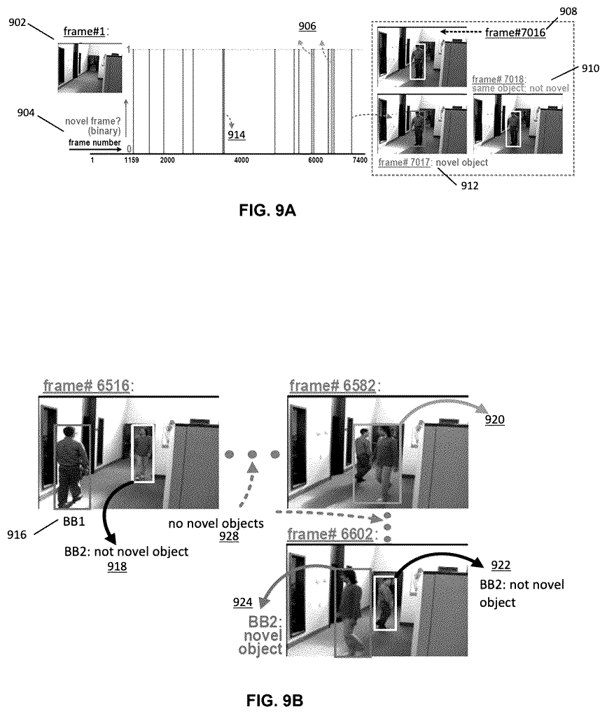

FIGS. 9A and 9B show the performance of the NDE in identifying novel content within video frames in conjunction with handling potential false positives due to occlusion, according to an embodiment of the present disclosure.

As shown in FIG. 9A, a background frame 902 is provided to serve as a reference to identify changes or novel objects in subsequent frames. The graph of FIG. 9A plots binary outcomes of novelty detection across frame numbers, with vertical lines indicating novel frames 904 where novel content was detected. For example, two frames in quick succession 914 are marked, indicating the detection of novelty was determined for these frames. Some frames may be identified as “Spurious Novel Frames” 906 which were incorrectly marked as containing novel content due to occlusion, which is a false positive. However, the false positives did not result in any “loss of information” i.e. did not cause the NDE to omit or overlook any truly novel objects or events. In frame #7016 (908), an object is detected that doesn't meet the minimum height threshold. Frame #7017 (912) introduces a truly novel object, while frame #7018 (910) detects the same object as frame #7017 (912), confirming it's not a novel object.

As shown in FIG. 9B, a first instance of a novel object is identified with a bounding box 1 (BB1) 916. A bounding box 2 (BB2) 918 is shown not meeting the minimum height threshold. No novel objects 928 in intermediate frames 928 between frame #6516 and frame #6582 and frame #6582 and frame #6602 may be determined. Similar to FIG. 9A, spurious novel objects 920 due to occlusion may be identified, i.e. objects incorrectly identified as novel content. Despite the earlier false positive in frame #6582, frame #6602 the system correctly identifies a novel object 924 with bounding box 2 (BB2) and the other object 922 as causing the occlusion as correctly not meeting the minimum height threshold. This correction is due to the addition of an erosion step in saliency detection 926 while helps reduce false positives due to occlusion. This process effectively minimizes the chances of isolated or noisy pixels causing incorrect novelty detection.

After the NDE identifies areas of interest in a video and draws boxes around them, it removes any that are too small, as they're likely just background noise. It then determines if the remaining objects are new by looking at their central points. By applying the “Manhattan distance” measurement between two consecutive video frames, it determines how much each object has moved: a small Manhattan distance indicates the object is not new but has been in the scene before, whereas a large Manhattan distance suggests the object is new or has significantly moved. The NDE preserves the information of these new or moved objects, adjusting their size appropriately, so they can be precisely analysed by the deep neural network (DNN).

Based on benchmarking and testing, the vision detection engine detailed in the present disclosure provides many technical advantages over previous designs. This engine provides a reduction in memory requirements by 22.8 to 99 times compared to other event detectors due to its on-the-fly architecture arrangement with minimal storage among stages and its linear computational complexity. The engine is versatile, suitable for a wide range of visual tasks, as opposed to prior designs that are tailored to specific applications like face detection or object tracking. With its hierarchical processing capability, the engine efficiently manages complex data structures, setting it apart from some of its predecessors.

The engine provides greater operational efficiency, supporting high-resolution input while maintaining lower memory requirements—11.6 KB for the event detector—compared to prior designs. The testing shows that it operates at a clock frequency of 2.45 MHz at 1.1 V and can process at a maximum frame rate of 60 fps, which is significantly higher than the other compared technologies, indicating its capability for real-time applications. Moreover, this high frame rate (3 pJ/pixel energy of saliency+novelty) marks an improvement over prior designs by 2.4-60×, indicative of its real-time processing capabilities.

The energy consumption metrics from benchmarking highlight the engine's power efficiency, requiring as little as 14.92 μW at 10 fps, with a scalable performance up to 580 μW at 60 fps. It has demonstrated a minimum energy usage of 2.4 pJ/pixel/frame for novelty detection and 3.0 pJ/pixel/frame when incorporating saliency detection, underscoring its capacity to operate at low power. With respect to reducing DNN activity, the engine has shown a reduction by 177 times solely from novelty detection, and increases to a 465 times reduction when combined with saliency detection, greatly exceeding the reduction rates of other models. These combined attributes show the engine's ability to enhance the efficacy of vision systems while adhering to the stringent power constraints of modern edge computing devices.

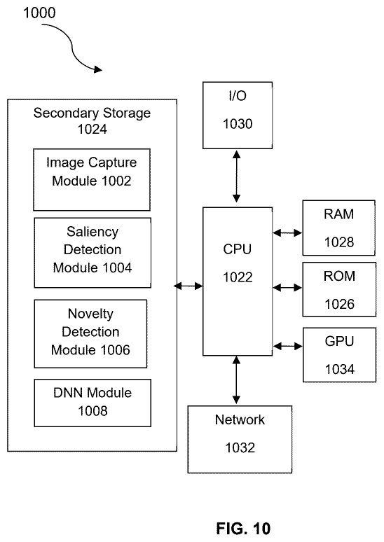

FIG. 10 is a block diagram showing a technical architecture of a novelty detection engine 130, according to an embodiment of the present disclosure. Typically, the methods are implemented by a number of computers each having a data-processing unit. The block diagram as shown in FIG. 10 illustrates a technical architecture 1000 of a computer which is suitable for implementing one or more embodiments herein.

The technical architecture 1000 includes a processor 1022 (which may be referred to as a central processor unit or CPU) that is in communication with memory devices including secondary storage 1024 (such as disk drives), read only memory (ROM) 1026, random access memory (RAM) 1028. The processor 1022 may be implemented as one or more CPU chips. The technical architecture 1020 may further comprise input/output (I/O) devices 1030, and network connectivity devices 1032.

The secondary storage 1024 is typically comprised of one or more disk drives or tape drives and is used for non-volatile storage of data and as an over-flow data storage device if RAM 1028 is not large enough to hold all working data. Secondary storage 1024 may be used to store programs which are loaded into RAM 1028 when such programs are selected for execution. In this embodiment, the secondary storage 1024 has an image capture module 1002, saliency detection module 1004, a novelty detection module 1006, and a DNN (Deep Neural Network) module 1008 comprising non-transitory instructions operative by the processor 1022 to perform various operations of the method of the present disclosure. As depicted in FIG. 10, the modules 1002-1006 are distinct modules which, when executed, perform respective functions implemented by the novelty detection engine 130. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the modules 1002-1006 is described herein, these may alternatively be implemented as one or more hardware modules (such as field-programmable gate array(s) or application-specific integrated circuit(s)) comprising circuitry which implements equivalent functionality to that implemented in software. The ROM 1026 is used to store instructions and perhaps data which are read during program execution. The secondary storage 1024, the RAM 1028, and/or the ROM 1026 may be referred to in some contexts as computer readable storage media and/or non-transitory computer readable media.

The I/O devices may include printers, video monitors, liquid crystal displays (LCDs), plasma displays, touch screen displays, keyboards, keypads, switches, dials, mice, track balls, voice recognizers, card readers, paper tape readers, or other well-known input devices.

In the computing device 1000, a graphics processing unit (GPU) 1034 can be included to enhance processing capabilities. The GPU 1034 is a specialized electronic circuit designed for rendering images, animations, and video, and is highly efficient at parallel processing tasks. This makes them well-suited for various data transmission, wireless communications, and artificial intelligence related operations. The GPU 1034 communicates with the processor 1022, secondary storage 1024, ROM 1026, RAM 1028, I/O devices 1030, and network connectivity devices 1032. It can be integrated within the processor 1022 as an integrated GPU (iGPU) or as a separate, dedicated GPU connected through a high-speed interface. Inclusion of the GPU 1034 allows for more efficient processing of tasks that benefit from parallelism, leading to increased system performance, especially in applications optimized for GPU-based processing. The GPU 1034 can also offload tasks from the CPU 1022, improving overall system efficiency. By incorporating the GPU 1034 into the computing device, the system can be transformed into a specific purpose machine with enhanced processing capabilities for parallel tasks, as taught by the present disclosure.

The network connectivity devices 1032 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 1032 may enable the processor 1022 to communicate with the Internet or one or more intranets. With such a network connection, it is contemplated that the processor 1022 might receive information from the network, or might output information to the network in the course of performing the method operations described herein. Such information, which is often represented as a sequence of instructions to be executed using processor 1022, may be received from and outputted to the network, for example, in the form of a computer data signal embodied in a carrier wave.

The processor 1022 executes instructions, codes, computer programs, scripts which it accesses from hard disk, floppy disk, optical disk (these various disk-based systems may all be considered secondary storage 1024), flash drive, ROM 1026, RAM 1028, or the network connectivity devices 1032. While only one processor 1022 is shown, multiple processors may be present. Thus, while instructions may be discussed as executed by a processor, the instructions may be executed simultaneously, serially, or otherwise executed by one or multiple processors.

It is understood that by programming and/or loading executable instructions onto the technical architecture 1000, at least one of the CPU 1022, the RAM 1028, and the ROM 1026 are changed, transforming the technical architecture 1000 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiments can be made within the scope of the invention as defined by the claims. Moreover, features of one or more embodiments may be mixed and matched with features of one or more other embodiments.

1. A method for processing video frame pixels, the method comprising:
receiving video frame pixels of a video frame and dividing the video frame into tiles;
processing each tile to identify a salient region;
applying a structured pattern to evaluate differences between a pair of pixels within each tile to evaluate the salient region;
processing the evaluated salient region to detect a novel object corresponding to the video frame; and
storing the novel object for further processing by a neural network.

2. The method of claim 1, wherein the detecting of the novel object corresponding to the video frame comprises:
forming a bounding box around the salient region;
tracking the movement of the bounding box across multiple video frames; and
comparing positions of the bounding box between the multiple video frames.

3. The method of claim 2, wherein the comparing of positions of the bounding box includes calculating a Manhattan distance between a centre of the bounding box in a first and a centre of the bounding box in a subsequent frame, to assess a movement of an object within the multiple frames.

4. The method of claim 2, wherein forming the bounding box comprises implementing a connected component analysis to identify a salient region associated with non-overlapping objects within the multiple frames.

5. The method of claim 4, wherein the connected component analysis computes a proximity or similarity in pixel values to identify a connected pixel group.

6. The method of claim 2, wherein tracking the movement of the bounding box across multiple video frames includes calculating a mean center of the bounding box for a first frame and a mean center of the bounding box for a second frame.

7. The method of claim 6, wherein the mean center corresponding to the first frame and the mean center corresponding to the second frame are compared to determine object novelty.

8. The method of claim 2, further comprising determining whether the movement of the bounding box exceeds a predetermined threshold, wherein the movement exceeding the threshold indicates an object corresponding to the bounding box is novel.

9. The method of claim 1, further comprising pre-processing the stored novel objects for compatibility with one or more specific neural network applications; or further comprising refining the salient regions by applying an erosion process followed by a dilation process to the salient regions, or further comprising using a Finite State Machine to control sequential operations corresponding to the processing of the salient region and the detection of the novel object.

10. (canceled)

11. The method of claim 1, wherein the density or distribution of the structured pattern is reconfigurable according a complexity of the received video frame pixels of the video frame.

12. (canceled)

13. The method of claim 1, wherein the processing of the salient region includes ceasing further processing of the video frame if no salient pixels are found.

14. A method for detecting novelty in video frames, the method comprising:
acquiring an input frame;
identifying a preliminary salient region within the input frame;
refining the preliminary salient region to generate a refined salient region;
computing a bounding box for the refined salient region;
calculating a mean center of the bounding box and tracking the mean center across multiple input frames.
calculating a distance corresponding to the tracked mean center; and
classifying an object corresponding to the bounding box as novel when the distance exceeds a predetermined threshold.

15. A system for identifying novel objects in a video sequence, the system comprising:
data processing module configured to receive and process image frames from a video sequence, divide each frame into tiles to assess salient regions and segment the salient regions column by column into distinct clusters and assign labels to each cluster;
a label management module configured to merge labels in neighbouring clusters, thereby forming an expanded group of clusters, wherein the expanded group of clusters are stored and objects within the expanded group of clusters are assessed for novelty based on positions within adjacent frames; and
a thresholding module configured to apply a thresholding mechanism to the expanded group of clusters based on a size or position of the expanded group of clusters.

16. The system of claim 15, wherein the thresholding module is configured to discard objects that are either minuscule or outside pre-defined regions of interest based on a size of a bounding box, or wherein the thresholding module is configured to execute a comparison algorithm to determine if the size of a bounding box falls within a range indicative of salient objects, wherein objects falling outside this range are discarded, or wherein the thresholding module is configured to utilize a Manhattan distance calculation to quantify a movement of a mean center of a bounding box between the adjacent frames.

17. The system of claim 15, wherein the expanded group of clusters correspond to bounding boxes that are stored in a table, wherein the bounding boxes are defined by a plurality of attributes.

18. The system of claim 15, wherein the label management module includes a label buffer that stores label and position information corresponding to the neighbouring clusters, or wherein the label management module is configured to merge the labels of the neighbouring clusters based on comparing the labels to determine a connectivity among the labels.

19. (canceled)

20. The system of claim 15, wherein the data processing module includes an encoder module configured to encode contiguous pixel sequences within the image frames of the video sequence.

21. The system of claim 15, wherein the thresholding module includes a feature extraction module configured to compute bounding boxes and assess novelty of an object within the bounding boxes.

22. The system of claim 21, wherein the feature extraction module is further configured to
calculate the mean center of the bounding boxes and to evaluate the movement of objects based on the location of the mean center over time.

23. (canceled)

24. The system of claim 15, further comprising a feature table for recording dimensions and positions of bounding boxes associated with objects identified as novel by the threshold module.

25. (canceled)
